(19) United States
(12) Patent Application Publication
(10) Pub. No.: US 2009/0206145 A1
(43) Pub. Date: Aug. 20, 2009

(54) REFLOW SYSTEM

(75) Inventors: Nobuaki Tamori, Saitama (JP); Fumihiro Yamashita, Saitama (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Tamura Corporation, Nerima-ku (JP); Tamura FA System Corporation, Sayama-City (JP)

(21) Appl. No.: 12/370,145

(22) Filed: Feb. 12, 2009

(30) Foreign Application Priority Data
Feb. 14, 2008 (JP) 2008-033415

(51) Int. Cl. B23K 37/06

(52) U.S. Cl. 228/15.1

(57) ABSTRACT

A reflow system in which a reflow furnace is sequentially divided into a plurality of zones along a conveying path of a heat target which is conveyed and by controlling temperatures of the plurality of zones, the heat target which is conveyed is reflowed has: a cooling and flux collecting apparatus circulating and cooling atmosphere gases in furnace bodies of a part or all of the plurality of zones and collecting a flux; and a flow rate control unit which is inserted into a circulating path of the atmosphere gas of each of the zones and can control a flow rate. When the temperature of the zone is reduced, by controlling the flow rate control unit, the flow rate is set to be higher than that upon collecting the flux.

### CROSS REFERENCES TO RELATED APPLICATIONS

The present application contains subject matter related to that disclosed in Japanese Priority Patent Application No. 2008-033415 filed in the Japan Patent Office on Feb. 14, 2008, the entire content of which is hereby incorporated by reference.

### BACKGROUND OF THE INVENTION

1. Field of the Invention

The invention relates to a reflow system and, more particularly, to a reflow system in which a time necessary for a switching operation can be set to a short time.

2. Description of the Related Arts

A reflow system in which solder compositions are previously supplied to electronic parts or a printed wiring board and the board is conveyed into a reflow furnace by a conveying conveyer is used. The reflow system has: the conveying conveyer for conveying the board; and a reflow furnace main body to which the board as a target to be heated (hereinbelow, also referred to as a heat target) is supplied by the conveying conveyer. The reflow furnace is divided into a plurality of zones, for example, along a conveying path starting from an inlet port and reaching an outlet port, and those plurality of zones are arranged in an in-line form. The plurality of zones have roles such as heating zone and cooling zone in accordance with their functions.

Each of the heating zones has an upper furnace body and a lower furnace body. For example, a hot air is blown to the board from the upper furnace body of the zone and a hot air is blown to the board from the lower furnace body, thereby fusing a solder in the solder compositions, so that an electrode of the board and the electronic part are soldered. In the reflow system, a desired soldering can be executed by controlling a surface temperature of the heat target, for example, the board in accordance with a desired temperature profile. When a kind of board, a kind of solder, or the like is changed, in order to improve operating efficiency, it is required to cope with the solder obtained after the change within a short time.

For example, in Patent Document 1 (JP-A-11-145611), a technique in which by turning off energization of a heater for heating and supplying the outside air or inert gas into a specific zone, a temperature of the specific zone is reduced in a short time has been disclosed. In Patent Document 2 (JP-A-6-170524), a technique in which by forcedly exhausting the high temperature warm air in a furnace and supplying a cold air into the furnace, the inside of the furnace is forcedly cooled has been disclosed.

### SUMMARY OF THE INVENTION

According to the techniques disclosed in Patent Documents 1 and 2, the cold atmosphere or inert gas is introduced from the outside to the high temperature gas in the furnace of the reflow system, thereby forcedly and rapidly reducing the temperature in the furnace. Although the atmosphere introducing method can be used at the time of switching from the reflow system to an adhesive agent hardening apparatus, it is difficult to apply it to a reflow system in which a reflow is executed under the atmosphere of the inert gas. Since the cold atmosphere or inert gas is introduced into the whole furnace, there is such a problem that it is unsuitable for temperature control which is finely made every zone.

Solder compositions which are used in the reflow system contain a powdery solder, a solvent, and a flux. The flux contains rosin and the like as components and acts as a coating material adapted to remove an oxide film on a metal surface to be soldered, prevent the surface from being oxidized again by heating upon soldering, and reduce a surface tension of the solder, thereby improving wetting. The flux is vaporized by heating and filled in the reflow furnace. The vaporized flux is liable to be adhered to the portion having a low temperature. When the vaporized flux is adhered, it drops from the adhered portion and there is also a case where it is adhered onto the upper surface of the board, so that performance of the board is deteriorated. There is also a case where since the vaporized flux is deposited to a portion whose temperature decreases in the furnace body or the like, a large influence is exerted on a reflowing step. Therefore, it is required to remove or collect the flux in the reflow furnace.

Although the method of introducing the cold air from the outside can rapidly reduce the temperature in the furnace as mentioned above, nothing is considered to condensation of the flux in association with the temperature decrease and it is necessary to individually equip a flux collecting apparatus.

It is, therefore, desirable to provide a reflow system which can rapidly reduce a temperature of a desired furnace of the reflow system and can, further, make use of the cooling operation for efficient collection of a flux.

According to an embodiment of the present invention, there is provided a reflow system in which a reflow furnace is sequentially divided into a plurality of zones along a conveying path of a heat target which is conveyed and by controlling temperatures of the plurality of zones, the heat target which is conveyed is reflowed, comprising:

a cooling and flux collecting apparatus circulating and cooling atmosphere gases in furnace bodies of a part or all of the plurality of zones and collecting a flux; and

a flow rate control unit which is inserted into a circulating path of the atmosphere gas of each of the zones and can control a flow rate,

wherein when the temperature of the zone is reduced, by controlling the flow rate control unit, the flow rate is set to be higher than that upon collecting the flux.

Specifically speaking, the furnace body of each of the zones is constructed by an upper furnace body and a lower furnace body and the cooling and flux collecting apparatus and the flow rate control unit are independently provided for each of the upper furnace body and the lower furnace body.

Preferably, among the plurality of zones, in the case of changing a set temperature in the zone, a gas of a temperature lower than that of the gas in the zone is additionally introduced to one or the plurality of zones.

The gas in the furnace body is supplied to the cooling and flux collecting apparatus from a portion where a pressure which is generated by a blower is high, and

the gas from the cooling and flux collecting apparatus is supplied to a portion where the pressure which is generated by the blower is low.

According to the embodiment of the invention, the cooling and flux collecting apparatus is provided for the furnace bodies of the plurality of zones of the reflow system, and the flow rate control unit is provided between the furnace body and the cooling and flux collecting apparatus. When the temperature of the zone is reduced, by controlling the flow rate control unit, the flow rate is set to be higher than that upon collecting the flux, so that the temperature can be reduced in a short time. In the ordinary operation, the flux can be collected by the cooling and flux collecting apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic diagram showing an outline of a reflow system according to an embodiment of the invention;

FIG. 2 is a graph showing an example of a temperature profile at the time of reflowing;

FIG. 3 is a cross sectional view showing an example of a construction of one zone of the reflow system according to the embodiment of the invention;

FIG. 4 is a schematic diagram typically showing a flow of a gas in an upper furnace body in the embodiment of the invention;

FIG. 5 is a schematic diagram for use in explanation of layout relations among radiator boxes, cooling and flux collecting apparatuses, and the reflow system in the embodiment of the invention;

FIG. 6 is across sectional view showing an example of a construction of one zone of a reflow system according to another embodiment of the invention; and

FIG. 7 is a schematic diagram for use in explanation of a layout relation among radiator boxes, cooling and flux collecting apparatuses, and the reflow system in another embodiment of the invention.

### DETAILED DESCRIPTION OF THE PREFERRED EMBODIMENTS

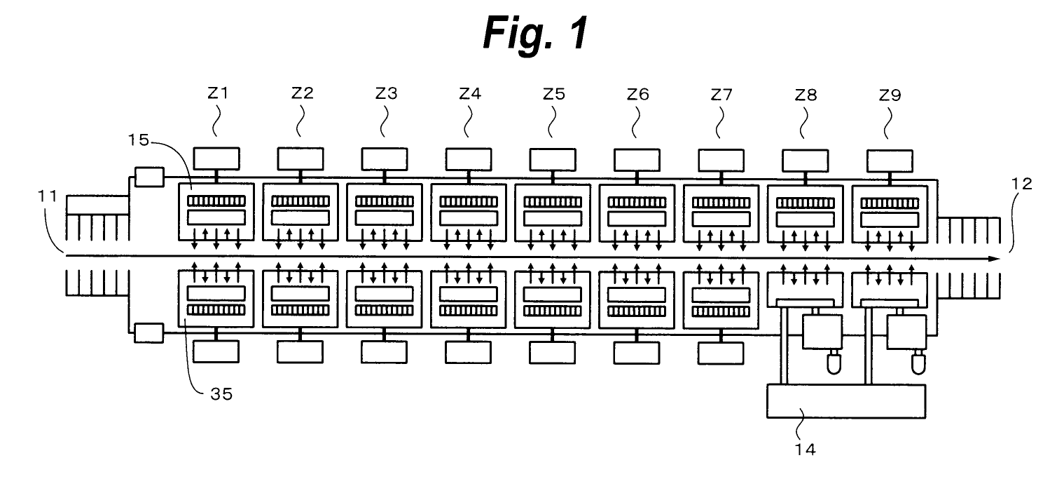

An embodiment of the invention will be described hereinbelow with reference to the drawings. FIG. 1 shows a schematic construction of a reflow system according to the embodiment of the invention excluding an outer panel. In FIG. 1, flux collecting apparatuses which are arranged out of a reflow furnace are not shown for convenience of explanation. The embodiment, which will be explained hereinbelow, is a preferred specific example of the invention and various kinds of limitation which are technically preferable are added. However, in the following description, it is assumed that the scope of the invention is not limited to those embodiments unless otherwise specified in order to limit the invention.

A target to be heated (hereinbelow, also referred to as a heat target) in which surface-mounting electronic parts have been mounted on both surfaces of a printed wiring board is put on a conveying conveyer and conveyed into a furnace body of the reflow system from an inlet port 11. The conveying conveyer conveys the heat target at a predetermined speed in the direction shown by an arrow (from the left to the right in FIG. 1) and the heat target is taken out of an outlet port 12.

The reflow furnace is sequentially divided into, for example, nine zones Z1 to Z9 along a conveying path starting from the inlet port 11 and reaching the outlet port 12. The zones Z1 to Z9 are arranged in an in-line form. The seven zones Z1 to Z7 from the inlet side are heating zones and the two zones Z8 and Z9 on the outlet side are cooling zones, respectively. A forced cooling unit 14 is provided in association with the cooling zones Z8 and Z9.

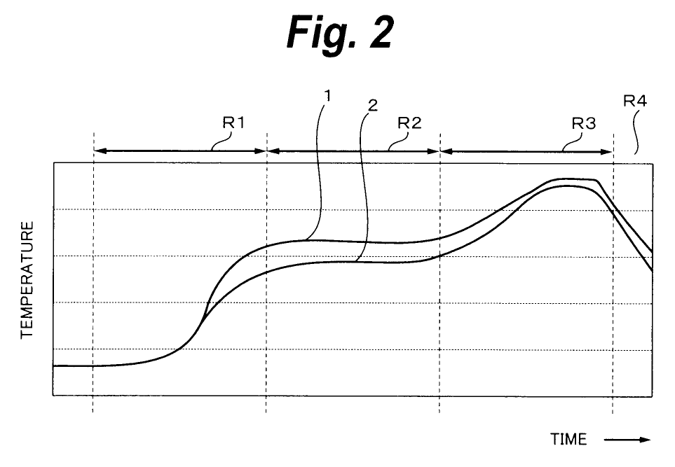

The plurality of zones Z1 to Z9 control a temperature of the heat target in accordance with a temperature profile at the time of reflowing. FIG. 2 shows an outline of an example of the temperature profile. An axis of abscissa indicates a time and an axis of ordinate indicates a surface temperature of the heat target, for example, the printed wiring board on which electronic parts have been mounted. The first interval is a temperature rising portion R1 where the temperature rises by heating. The next interval is a preheating portion R2 where the temperature is almost constant. The further next interval is a main heating portion R3. The last interval is a cooling portion R4.

The temperature rising portion R1 is a period for heating the board from the ordinary temperature to the preheating portion R2 (for example, 150° C. to 170° C.). The preheating portion R2 is a period for performing isothermal heating, activating the flux, removing oxide films on the surfaces of an electrode and solder powder, and eliminating a heating variation of the printed wiring board. The main heating portion R3 (for example, 220° C. to 240° C. as a peak temperature) is a period during which the solder is fused and a junction is completed. In the main heating portion R3, it is necessary to raise the temperature to a temperature exceeding a melting temperature of the solder. In the main heating portion R3, since a variation in temperature elevation exists even after the elapse of the preheating portion R2, it is necessary to heat up to the temperature exceeding the melting temperature of the solder. The last cooling portion R4 is a period for rapidly cooling the printed wiring board and forming solder compositions.

In FIG. 2, a curve 1 shows a temperature profile of a lead-free solder. A temperature profile of an eutectic solder is as shown in a curve 2. Since a melting point of the lead-free solder is higher than that of the eutectic solder, a set temperature in the preheating portion R2 is assumed to be higher than that of the eutectic solder.

In the reflow system, mainly, the zones Z1 and Z2 have charge of temperature control of the temperature rising portion R1 in FIG. 2. Mainly, the zones Z3, Z4, and Z5 have charge of temperature control of the preheating portion R2. The zones Z6 and Z7 have charge of temperature control of the main heating portion R3. The zones Z8 and Z9 have charge of temperature control of the cooling portion R4.

Each of the heating zones Z1 to Z7 has an upper furnace body 15 and a lower furnace body 35 each including a blower. For example, the hot air is blown from the upper furnace body 15 and the lower furnace body 35 of the zone Z1 to the heat target which is conveyed.

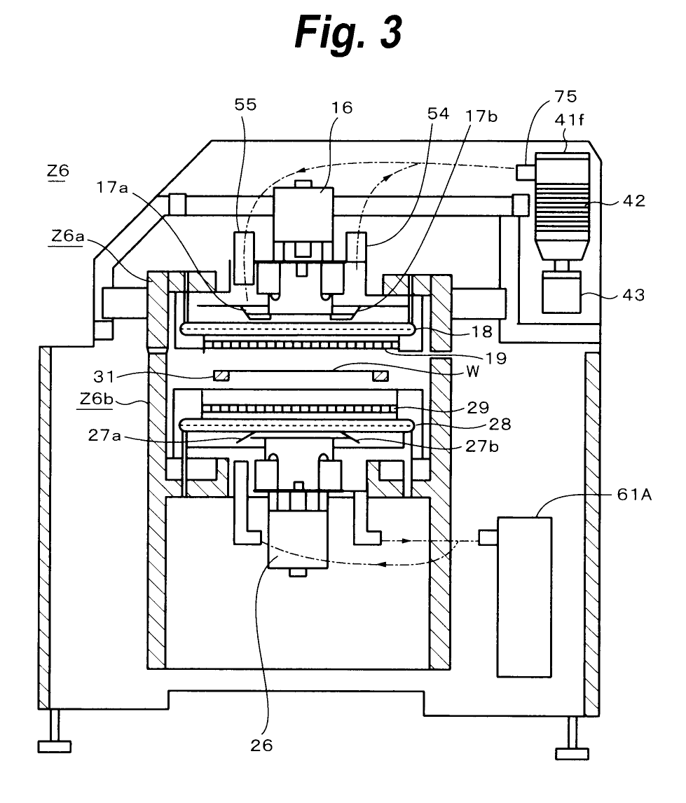

An example of a heating apparatus will be described with reference to FIG. 3. FIG. 3 shows a cross section in the case where, for example, the zone Z6 is cut at a surface which perpendicularly crosses the conveying direction. In a facing interval between an upper furnace body Z6a and a lower furnace body Z6b, a target W to be heated (hereinbelow, also referred to as a heat target W) in which surface-mounting electronic parts have been mounted on both surfaces of the printed wiring board is put on a conveying conveyer 31 and conveyed. For example, a nitrogen gas N₂ as an atmosphere gas is filled in each of the upper furnace body Z6a and the lower furnace body Z6b. The upper furnace body Z6a and the lower furnace body Z6b blow the hot air (for example, heated atmosphere gas) to the heat target W, thereby heating the heat target W. Infrared rays may be irradiated together with the hot air.

The upper furnace body Z6a has: a blower 16 having a construction of, for example, a turbo fan; a heater 18 formed by folding back a heater line a plurality of number of times; and a panel (heat accumulating member) 19 having a number of small holes through which the hot air passes. The hot air which passed through the small holes of the panel 19 is blown to the heat target W from the upper side. The panel 19 is made of, for example, aluminum.

The lower furnace body Z6b also has a construction similar to that of the upper furnace body Z6a mentioned above. That is, the lower furnace body Z6b has: a blower 26 having a construction of, for example, a turbo fan; a heater 28 formed by folding back a heater line a plurality of number of times; and a panel (heat accumulating member) 29 having a number of small holes through which the hot air passes. The hot air which passed through the small holes of the panel 29 is blown to the heat target W from the lower side.

A radiator box 41f as a cooling and flux collecting apparatus is provided for the upper furnace body Z6a. For example, in a space surrounded by an outer panel, the radiator box 41f is arranged on the rear side of the upper furnace body Z6a. A cooling and flux collecting apparatus 61A is provided for the lower furnace body Z6b. For example, in the space surrounded by an outer panel, the cooling and flux collecting apparatus 61A is arranged on the rear side of the lower furnace body Z6b. The radiator box 41f is formed by: a radiator portion 42 for cooling the atmosphere gas derived from the upper furnace body Z6a; and a collecting container 43 for collecting the flux liquefied by cooling. The cooling and flux collecting apparatus 61A cools the atmosphere gas derived from the lower furnace body Z6b by a cooling method in which an air-cooling and a water-cooling are combined.

The atmosphere gas in the furnace is circulated and cooled in the radiator box 41f and the cooling and flux collecting apparatus 61A and returned into the furnace. Although not shown, valves as flow rate control means for controlling a flow rate of the gas within a range of 0% (shut-off) to 100% (full-open) is provided in such a circulating path. The valves can be individually controlled and are controlled so as to circulate the gas of a proper flow rate in each of a normal operating mode and a switching mode.

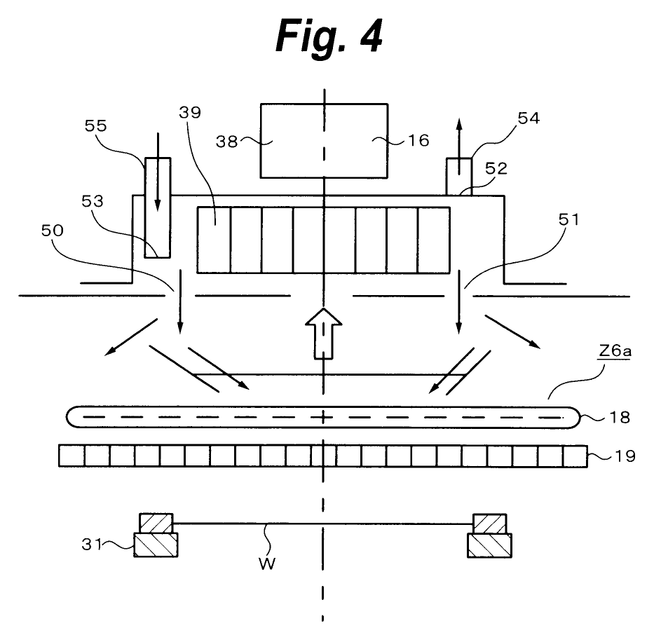

FIG. 4 schematically shows a flow of the air in the upper furnace body Z6a. The blower 16 has a motor 38 and blades 39 which are rotated by the motor 38. In the case of the turbo fan, when the blades 39 are rotated, the air is blown from two peripheral positions and fed into the upper furnace body Z6a through holes 50 and 51 formed at two positions in an upper portion of the furnace body. Further, the air passes through the heater 18 and the panel 19 and is blown to the heat target W. The blower 16 further introduces the atmosphere gas in the furnace through a hole near a center portion.

A hole 52 as an outlet port for guiding the atmosphere gas to the radiator box 41f is formed in the path along which the hot air is circulated by the blower 16. The hole 52 is formed at a position of a high pressure in the furnace. A hole 53 as an inlet port for guiding the gas from the radiator box 41f into the upper furnace body Z6a is formed at a position of a low pressure. Actually, each of the holes 52 and 53 corresponds to an opening on one end side of each of pipes 54 and 55 for connecting. Each of the connecting pipes 54 and 55 and a connecting pipe of the radiator box 41f are connected by a hose (not shown). Also in the lower furnace body Z6b, the atmosphere gas is guided to the cooling and flux collecting apparatus 61A from the hole formed at the position of the high pressure in the furnace. The gas whose flux component has been reduced from the cooling and flux collecting apparatus 61A is introduced from the hole formed at the position of the low pressure in the furnace.

The radiator box 41f and the cooling and flux collecting apparatus 61A are provided in association with all zones or a plurality of partial zones of the reflow system.

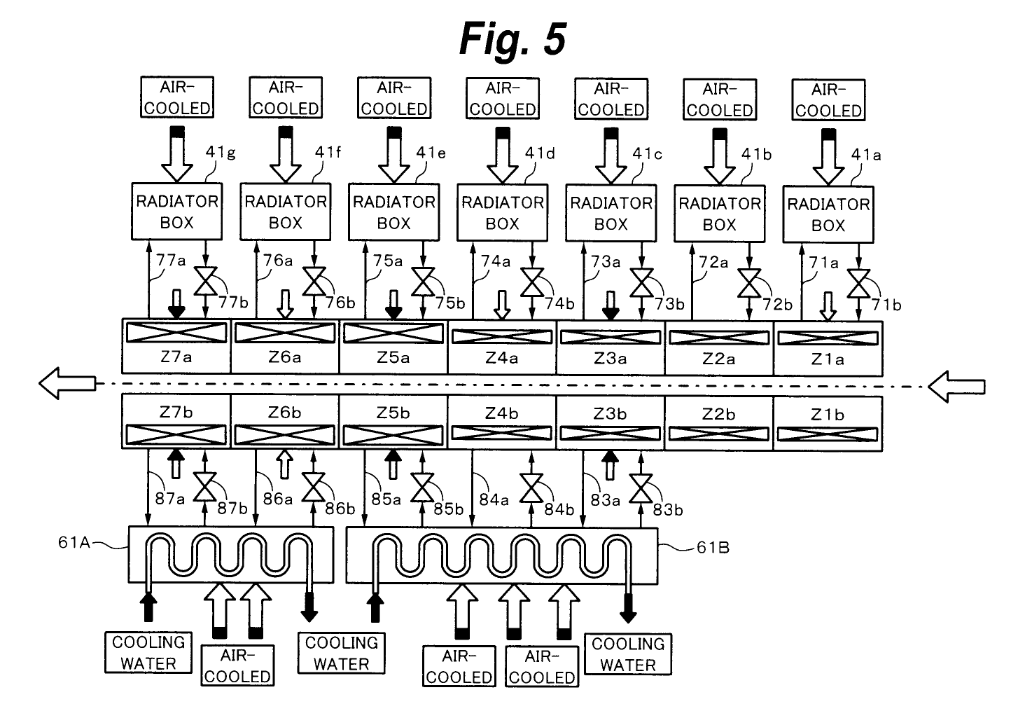

FIG. 5 schematically shows layout relations among a plurality of zones (constructed by upper furnace bodies Z1a, Z2a, . . . , Z7a and lower furnace bodies Z1b, Z2b, . . . , Z7b) arranged in an in-line form, radiator boxes 41a to 41g, and cooling and flux collecting apparatuses 61A and 61B. As an atmosphere gas in the furnace, an inert gas, for example, a nitrogen gas N₂ is used.

At the time of reflowing, control is made in such a manner that the heat target is conveyed at a predetermined speed in facing intervals between the upper furnace bodies Z1a, Z2a, . . . , Z7a and the lower furnace bodies Z1b, Z2b, . . . , Z7b and a temperature of each of the upper furnace bodies and the lower furnace bodies is set to a preset temperature. Further, a blowing amount of the blower is also set to a predetermined value.

An N₂ generating apparatus (not shown) generates N₂ by vaporizing, for example, liquefied nitrogen of a super low temperature. As shown by blank arrows, upon operation, N₂ is supplied to the furnace bodies Z1a, Z4a, Z6a, and Z6b, respectively. Separately from such a main N₂supplying path, a sub N₂ supplying path is provided and a valve is arranged for the sub N₂ supplying path, thereby allowing N₂ to supplied into the furnace through the sub supplying path as necessary. For example, when switching the eutectic solder and the lead-free solder as a kind of solder, there is a case where it is necessary to reduce the temperature in the furnace. For example, when an actual temperature is higher than a temperature which is set for the kind of new solder by 10° C. or more, it is necessary to reduce the temperature in the furnace within a permissible range (for example, a difference of 5° C.). Such a temperature difference can be detected by a method whereby the operator monitors a display panel (not shown) for control or can be automatically detected by a temperature sensor. Control is made so as to reduce the detected temperature difference to the permissible range.

As mentioned above, when the temperature is reduced in association with the switching, as shown by arrows whose head portions have been painted, N₂ at an ordinary temperature is additionally supplied to desired ones of the furnace bodies Z3a, Z3b, Z5a, Z5b, Z7a, and Z7b through the foregoing sub supplying path, respectively. A gas outlet port and a gas inlet port are provided for each furnace body. In the furnace, the gas outlet port is formed at a high pressure position. In the furnace, the gas inlet port is formed at a low pressure position.

The temperature can be switched in a short time by rapidly reducing the temperature in the furnace. In addition to the additional supply of N₂, the atmosphere gas in the furnace is circulated and cooled in the radiator boxes and the cooling and flux collecting apparatuses. In the example of FIG. 5, the radiator boxes 41a to 41g are provided in association with all of the upper furnace bodies Zia to Z7a. The radiator boxes 41a to 41g are apparatuses for cooling the atmosphere gas by the air-cooling method and collecting the flux as described with reference to FIG. 3. The atmosphere gases are introduced into the radiator boxes 41a to 41g from the upper furnace bodies Z1a to Z7a through ducts 71a to 77a, respectively. The gases obtained after the cooling are returned to the upper furnace bodies Z1a to Z7a through the ducts and valves 71b to 77b, respectively.

The cooling and flux collecting apparatuses 61A and 61B are provided in association with the lower furnace bodies. Each of the cooling and flux collecting apparatuses has a construction as a circulating cooling box having an air-cooled capacitor and water-cooled capacitor therein. The atmosphere gas from the furnace body is introduced into the box and the atmosphere gas which was sufficiently cooled in the box is returned into the furnace through the valve.

The atmosphere gases are introduced into the cooling and flux collecting apparatus 61A from the lower surfaces of the lower furnace bodies Z6b and Z7b through ducts 86a and 87a, respectively. In the cooling and flux collecting apparatus 61A, the atmosphere gases are cooled and the flux which was aggregated or solidified by the cooling is collected. The cooled gases are returned from the bottom surfaces of the lower furnace bodies Z6b and Z7b through valves 86b and 87b, respectively. The atmosphere gases are circulated in the cooling and flux collecting apparatus 61A by a pressure difference.

The atmosphere gases are introduced into the cooling and flux collecting apparatus 61B from the lower surfaces of the lower furnace bodies Z3b, Z4b, and Z5b through ducts 83a, 84a, and 85a, respectively. In the cooling and flux collecting apparatus 61B, the atmosphere gases are cooled and the flux which was aggregated or solidified by the cooling is collected. The cooled gases are returned from the bottom surfaces of the lower furnace bodies Z3b, Z4b, and Z5b through valves 83b, 84b, and 85b, respectively. The atmosphere gases are circulated in the cooling and flux collecting apparatus 61B by a pressure difference.

The valves 71b to 77b are arranged between the upper furnace bodies Z1a to Z7a and the radiator boxes 41a to 41g, respectively. The valves 83b to 87b are arranged between the lower furnace bodies Z3b to Z7b and the cooling and flux collecting apparatuses 61A and 61B, respectively. Those valves can independently control a flow rate within a range of 0% to 100%. As a valve, a construction of a single control valve or a construction of a combination of a closable valve and flow rate control means can be used.

Both of the normal operation and the switching operation for changing the set temperature of each zone in accordance with a type of solder, a type of board, or the like are executed. In both of the normal operation and the switching operation, the main supplying operation of N₂ is continuously executed. If a temperature difference of, for example, 10° C. or more exists upon switching, the cooling operation is executed. When switching from the lead-free solder to the eutectic solder, for example, it is necessary to reduce a heater temperature of each of the zones Z3, Z4, and Z5 by 30° C. and it is also necessary to similarly reduce the temperature in the furnace. The operation for reducing the temperature in a short time in such a case is the cooling operation.

The cooling operation is constructed by: the operation for additionally supplying N₂ through the sub supplying path; and the operation for fully opening the valve between the radiator box or the cooling and flux collecting apparatus and the furnace body. For example, the operation for remarkably reducing the temperature of each of the zones Z3, Z4, and Z5 is executed by: the heater-off operation for turning off heaters of those zones; the additional supplying operation of N₂ to the zones Z3 and Z5; and the full-opening operation of the valves 73b, 74b, 75b, 83b, 84b, and 85b. Thus, the temperatures of those zones can be reduced in the short time. By the cooling operation, the valve is closed from the zone in which the temperature difference lies within the permissible range such as 5° C. or less or the valve is closed to an extent necessary for collection of the flux.

In the embodiment of the invention, the radiator boxes 41a to 41g are provided for all of a plurality of zones each of which is constructed by the upper furnace body and the lower furnace body. Therefore, the temperature control of all of the zones can be desirably made. For the zone in which it is largely necessary to fairly cool, since the cooling and flux collecting apparatus is provided for the lower furnace body, the temperature reduction in the short time can be realized. Further, since not only whether or not the atmosphere gas is circulated in the radiator boxes 41a to 41g but also the flow rate of the gas which is circulated can be controlled in accordance with an opening degree of the valve, at the time of the normal operation, the flow rate is set to be lower than that upon switching and the flux can be collected. Moreover, at the time of the normal operation, the flow rate can be independently controlled every zone in consideration of a degree of occurrence of the flux or the like and the flux can be effectively collected. In addition, also at the time of the switching operation, the flux collecting operation can be continued and the flux can be effectively collected. Furthermore, the valve can be automatically controlled and the working efficiency can be improved.

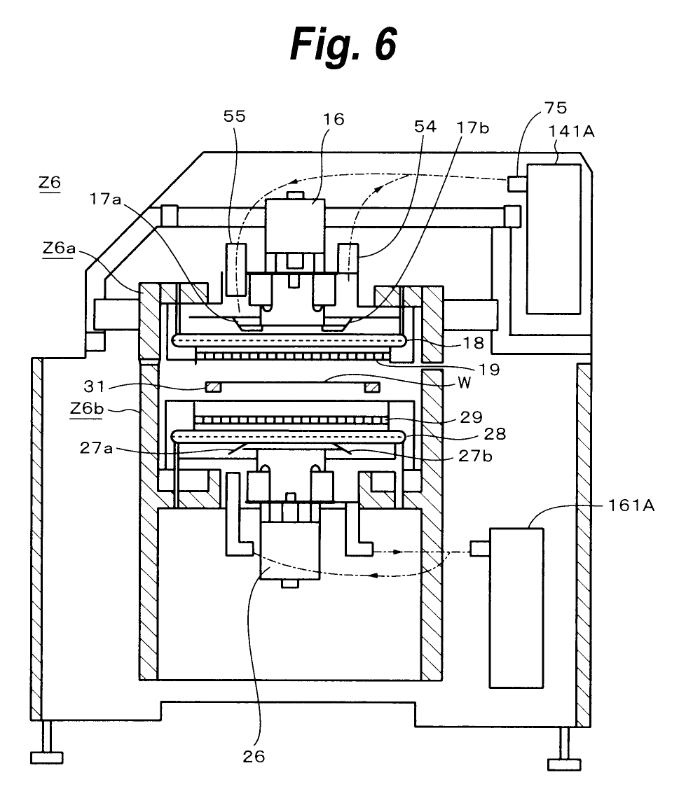

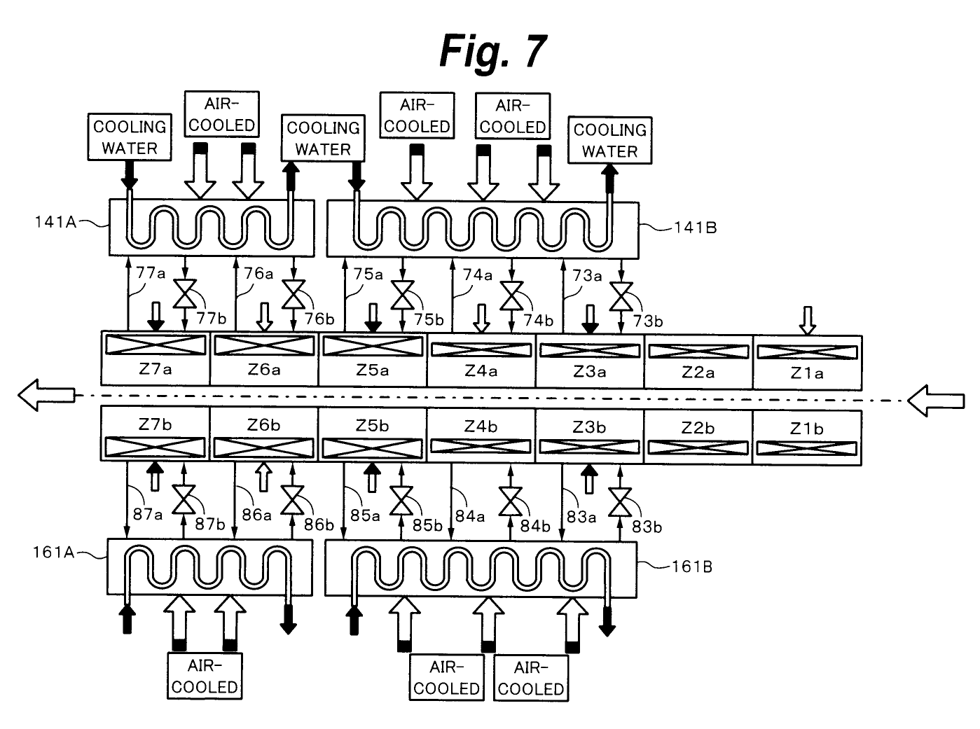

Another embodiment of the invention will now be described with reference to FIGS. 6 and 7. In a manner similar to FIG. 3, FIG. 6 illustrates a cross section in the case where, for example, the zone Z6 is cut at a surface which perpendicularly crosses the conveying direction. A construction of each of the upper furnace body Z6a and the lower furnace body Z6b is similar to that described with reference to FIG. 3.

In another embodiment, in place of the radiator box 41f, a cooling and flux collecting apparatus 141A is provided for the upper furnace body Z6a. For example, in the space surrounded by the outer panel, the cooling and flux collecting apparatuses 141A is arranged on the rear side of the upper furnace body Z6a. A cooling and flux collecting apparatus 161A is provided for the lower furnace body Z6b. For example, in the space surrounded by the outer panel, the cooling and flux collecting apparatus 161A is arranged on the rear side of the lower furnace body Z6b. The cooling and flux collecting apparatus 141A is formed by a collecting portion for cooling the atmosphere gas derived from the upper furnace body Z6a and collecting the flux liquefied by the cooling. Similarly, the cooling and flux collecting apparatus 161A is formed by a collecting portion for cooling the atmosphere gas derived from the lower furnace body Z6b and collecting the flux liquefied by the cooling.

FIG. 7 schematically shows a layout relation between a plurality of zones (constructed by the upper furnace bodies Z1a, Z2a, . . . , Z7a and the lower furnace bodies Z1b, Z2b, . . . , Z7b) arranged in an in-line form and cooling and flux collecting apparatuses 141A, 141B, 161A, and 161B. As an atmosphere gas in the furnace, an inert gas, for example, a nitrogen gas N₂ is used.

At the time of reflowing, control is made in such a manner that the heat target is conveyed at the predetermined speed in the facing intervals between the upper furnace bodies Z1a, Z2a, . . . , Z7a and the lower furnace bodies Z1b, Z2b, . . . , Z7b and the temperature of each of the upper furnace bodies and the lower furnace bodies is set to the preset temperature. Further, the blowing amount of the blower is also set to the predetermined value.

The cooling and flux collecting apparatuses 161A and 161B are provided in association with each of the lower furnace bodies Z3b, Z4b, Z5b, Z6b, and Z7b. A construction for cooling associated with the lower furnace bodies is similar to that in the embodiment of the invention. The cooling operation is executed by: the additional supply of N₂through the sub supplying path; and the circulating cooling of the cooling and flux collecting apparatuses.

The cooling and flux collecting apparatuses 141A and 141B are provided in association with each of the upper furnace bodies Z3a, Z4a, Z5a, Z6a, and Z7a. In a manner similar to the cooling and flux collecting apparatuses 161A and 161B, each of the cooling and flux collecting apparatuses 141A and 141B has a construction as a circulating cooling box having an air-cooled and water-cooled capacitor therein. The atmosphere gas from the furnace body is introduced into the box by the pressure difference and the atmosphere gas which was sufficiently cooled in the box is returned into the furnace through the valves 73b, 74b, 75b, 76b, and 77b. The flux is collected in the cooling and flux collecting apparatuses 141A and 141B.

In addition to the additional supply of N₂, the atmosphere gas in the furnace is circulated and cooled in the cooling and flux collecting apparatuses 141A, 141B, 161A, and 161B, thereby rapidly reducing the temperature in the furnace, so that the switching operation can be executed in a short time.

Also in another embodiment of the invention, the valves 73b to 77b and 83b to 87b can independently control the flow rate within a range of 0% to 100%. As a valve, the construction of the single control valve or the construction of a combination of the closable valve and the flow rate control means can be used.

Both of the normal operation and the switching operation for changing the set temperature of each zone in accordance with the type of solder, the type of board, or the like are executed. In both of the normal operation and the switching operation, the main supplying operation of N₂ is continuously executed. If a temperature difference of, for example, 10° C. or more exists upon switching, the cooling operation is executed.

The cooling operation is constructed by: the operation for additionally supplying N₂ through the sub supplying path; and the operation for fully opening the valve between the cooling and flux collecting apparatus and the furnace body. For example, in the case of remarkably reducing the temperature of each of the zones Z3, Z4, and Z5, the heater-off operation for turning off heaters of those zones, the additional supplying operation of N₂ to the zones Z3 and Z5, and the full-opening operation of the valves 73b, 74b, 75b, 83b, 84b, and 85b are executed. Thus, the temperatures of those zones can be reduced in the short time. By the cooling operation, the valve is closed from the zone in which the temperature difference lies within the permissible range such as 5° C. or less or the valve is opened to an extent necessary for collection of the flux.

In another embodiment of the invention, the cooling and flux collecting apparatuses are provided for a plurality of zones having a possibility that the cooling operation is necessary. Therefore, the temperature control of those zones can be desirably made. Since the cooling and flux collecting apparatuses are provided on the upper and lower sides, the cooling stronger than the cooling which is executed only by the air-cooling can be performed and the temperature reduction in the short time can be realized. Further, since not only whether or not the atmosphere gas is circulated in the cooling and flux collecting apparatus but also the flow rate of the gas which is circulated can be controlled by the valve, at the time of the normal operation, the flow rate is set to be lower than that upon switching and the flux can be collected. Moreover, at the time of the normal operation, the flow rate can be independently controlled every zone in consideration of a degree of occurrence of the flux or the like and the flux can be effectively collected. In addition, also at the time of the switching operation, the flux collecting operation can be continued and the flux can be effectively collected. Furthermore, the valve can be automatically controlled and the working efficiency can be improved.

Although the embodiments of the invention have specifically been described above, the invention is not limited to the foregoing embodiments but various modifications based on the technical idea of the invention are possible. For example, the cooling operation according to the invention can be also applied to the switching of an element other than the solder type, for example, to the switching of a temperature profile. Further, in the case of returning the gas from the radiator box or the cooling and flux collecting apparatus into the furnace body, in order to prevent a reduction in temperature in the furnace, after the gas to be returned was heated, it may be returned. Moreover, the cooling and flux collecting apparatus can be also provided in common for all of the zones or, contrarily, the cooling and flux collecting apparatus may be provided for each zone.

What is claimed is:

1. A reflow system in which a reflow furnace is sequentially divided into a plurality of zones along a conveying path of a heat target which is conveyed and by controlling temperatures of said plurality of zones, said heat target which is conveyed is reflowed, comprising:
a cooling and flux collecting apparatus circulating and cooling atmosphere gases in furnace bodies of a part or all of said plurality of zones and collecting a flux; and
a flow rate control unit which is inserted into a circulating path of said atmosphere gas of each of said zones and can control a flow rate,
wherein when the temperature of the zone is reduced, by controlling said flow rate control unit, said flow rate is set to be higher than that upon collecting the flux.

2. The reflow system according to claim 1, wherein the furnace body of each of said zones is constructed by an upper furnace body and a lower furnace body and said cooling and flux collecting apparatus and said flow rate control unit are independently provided for each of said upper furnace body and said lower furnace body.

3. The reflow system according to claim 1, wherein among said plurality of zones, in the case of changing a set temperature in said zone, a gas of a temperature lower than that of the gas in said zone is additionally introduced to one or a plurality of said zones.

4. The reflow system according to claim 1, wherein
the gas in said furnace body is supplied to said cooling and flux collecting apparatus from a portion where a pressure which is generated by a blower is high, and
the gas from said cooling and flux collecting apparatus is supplied to a portion where the pressure which is generated by said blower is low.
